(19) United States
(12) Patent Application Publication
(10) Pub. No.: US 2020/0283165 A1
(43) Pub. Date: Sep. 10, 2020

(54) SYSTEMS AND METHODS FOR ALERTING NON-COMPLIANCE WITH STANDARD OPERATING PROCEDURES IN AVIATION

(71) Applicant: Honeywell International Inc., Morris Plains, NJ (US)

(72) Inventors: Nathan KRISHNAMOORTHY, Bangalore (IN); Anoop S, Bangalore (IN); Sunitha PANCHANGAM, Bangalore (IN); Justin SCHASSLER, Glendale, AZ (US)

(73) Assignee: Honeywell International Inc.

(21) Appl. No.: 16/297,071

(22) Filed: Mar. 8, 2019

(51) Int. Cl. B64D 45/00; G08G 5/00

(52) U.S. Cl. CPC B64D 45/00; G08G 5/0013; G08G 5/0021

(57) ABSTRACT

Systems and methods are disclosed for alerting non-compliance with aviation standard operating procedures. In some examples, a method may include: determining an operating condition of an aircraft; based on the determined operating condition, determining one or more actions of operating the aircraft expected to be performed by an operator of the aircraft to adhere to a standard operating procedure applicable to the operating condition; determining whether the one or more actions have been performed; and upon determining that the one or more expected actions have not been performed, alerting the operator or an air traffic controller to indicate that the aircraft is not adhering to the applicable standard operating procedure.

### TECHNICAL FIELD

Various embodiments of the present disclosure relate generally to management of aircraft safety, and, in particular, to tracking standard operating procedure (SOP) adherence and alerting SOP non-compliance.

### BACKGROUND

When operating aircraft, pilots may be faced with circumstances that require certain actions to be taken in order to adhere to a standard operating procedure. For example, the aircraft may transition between different airspaces, stages of flight, and/or other operating conditions, and a standard operating procedure may require certain actions to be taken when such transitions occur.

Therefore, there is a need for systems and methods for tracking an aircraft's adherence to a standard operating procedure, and alerting the pilot or other involved parties, such as an air traffic controller, when the aircraft is not adhering to the standard operating procedure.

The present disclosure, in various aspects, is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for alerting non-compliance with aviation standard operating procedures.

For example, a method may include: determining an operating condition of an aircraft; based on the determined operating condition, determining one or more actions of operating the aircraft expected to be performed by an operator of the aircraft to adhere to a standard operating procedure applicable to the operating condition; determining whether the one or more actions have been performed; and upon determining that the one or more expected actions have not been performed, alerting the operator or an air traffic controller to indicate that the aircraft is not adhering to the applicable standard operating procedure.

Furthermore, a computer system may include a memory storing instructions; and one or more processors configured to execute the instructions to perform operations including: determining an operating condition of an aircraft; based on the determined operating condition, determining one or more actions of operating the aircraft expected to be performed by an operator of the aircraft to adhere to a standard operating procedure applicable to the operating condition; determining whether the one or more actions have been performed; and upon determining that the one or more expected actions have not been performed, alerting the operator or an air traffic controller to indicate that the aircraft is not adhering to the applicable standard operating procedure.

Furthermore, a non-transitory computer-readable medium may store instructions that, when executed by one or more processors of a computer system, cause the one or more processors to perform a method for tracking adherence of an aircraft to standard operating procedure. The method may include determining an operating condition of an aircraft; based on the determined operating condition, determining one or more actions of operating the aircraft expected to be performed by an operator of the aircraft to adhere to a standard operating procedure applicable to the operating condition; determining whether the one or more actions have been performed; and upon determining that the one or more expected actions have not been performed, alerting the operator or an air traffic controller to indicate that the aircraft is not adhering to the applicable standard operating procedure.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram depicting an example of a system environment, according to one or more embodiments.

FIG. 2 is a flowchart depicting an example of a method for tracking adherence to a standard operating procedure and alerting non-adherence, according to one or more embodiments.

FIG. 3 is a flowchart depicting an example of a method for tracking adherence to standard operating procedure and alerting non-adherence in an example context, according to one or more embodiments.

FIG. 4 is a flowchart depicting an example of a method for tracking adherence to standard operating procedure and alerting non-adherence in another example context, according to one or more embodiments.

FIG. 5 depicts an example of a computer system, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus.

In the following description, embodiments will be described with reference to the accompanying drawings. In various embodiments, a computer system may determine an action expected to be performed by a pilot of an aircraft in order to comply with a standard operating procedure. Such an action may be determined based on operating conditions of the aircraft and any instructions that the aircraft has received from air traffic controllers. If the pilot does not perform the action, the computer system may alert the pilot and an air traffic controller to indicate that the aircraft is not adhering to standard operating procedure. Accordingly, the pilot or air traffic controller may take action to correct the non-compliance or otherwise mitigate safety risks.

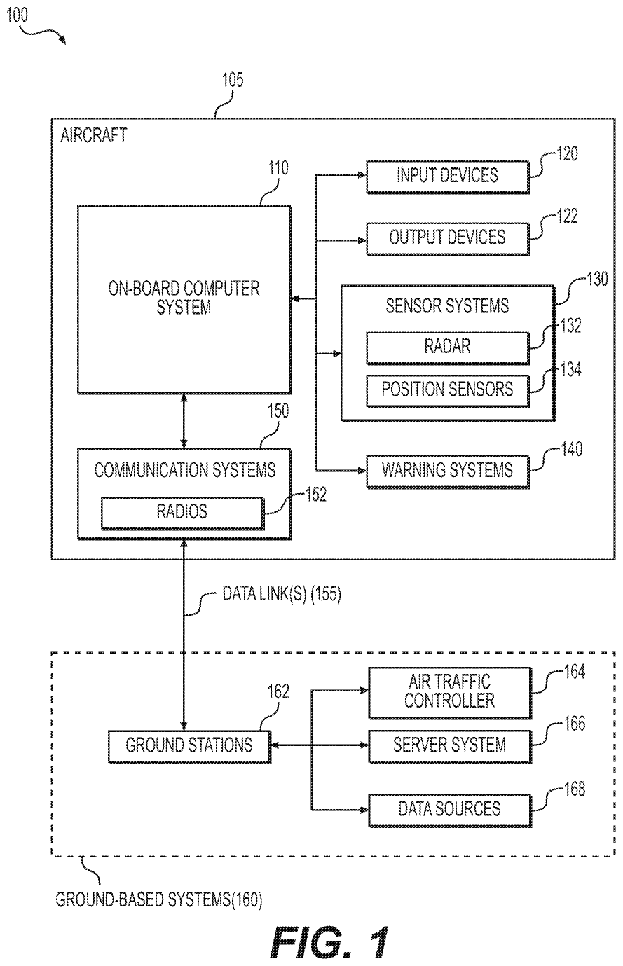

FIG. 1 illustrates a system environment 100 comprising an aircraft 105 connected to various ground systems 160. The aircraft may include various avionics and electronics systems, such as on-board computer system 110, input devices 120, output devices 122, sensor systems 130, warning systems 140, and communication systems 150.

The on-board computer system 110 may be, for example, a flight management system (FMS) of the aircraft 105 or a component of the flight management system. The computer system 110 may include a memory storing instructions and one or more processors configured to execute the instructions to perform various operations described in this disclosure. The memory may also store databases, such as terrain and navigation databases.

Sensor systems 130 may include any sensor used by aircraft 105. For example, sensor systems 130 may include a radar 132 and position sensors 134. Position sensors 134 may include, for example, a global positioning system (GPS), an altimeter, and/or any other type of position sensor. Sensor systems 130 may provide information, such as aircraft position, speed, direction, and altitude, to be used by the on-board computer system 110 or the warning systems 140. Radar 132 may include one or more radars, such as a weather radar configured to measure external weather conditions. In some examples, sensor systems 130 may include a transponder, which may be used by an ACAS for detection of other aircraft.

Warning systems 140 may include safety nets that issue safety alerts upon detection of a condition hazardous to safety. Such safety nets may have a configurable setting to inhibit alerts of that safety net. Warning systems 140 may include, for example, a terrain awareness and warning system (TAWS) (e.g., ground proximity warning system (GPWS) or enhanced ground proximity warning system (EGPWS)) and an airborne collision avoidance system (ACAS) (e.g., traffic collision avoidance system (TCAS)). A safety net may also be referred to as a safety system.

Communication systems 150, which may also be referred to as a communication interface, may establish data links 155 to permit the aircraft 105 to transmit data to, and receive data from, any of the ground systems 160. Data links 155 may provide any suitable network connection (e.g., an internet connection) between the aircraft 105 and the ground systems 160. Ground systems 160 may include, for example, one or more ground stations 162, an air traffic controller 164, a server system 166, and data sources 168. Communication systems 150 may enable communications between the aircraft 105 and the ground systems 160 using any suitable communications technology, such as controller pilot data link communications (CPDLC), Wi-Fi, and satellite communications (SATCOM).

Communication systems 150 may include components such as radios 152, which may include any combination of transmitters, receivers, and/or transceivers. For example, radios 152 may provide for communications in HF, VHF, UHF, and SHF frequency ranges. Any of the data links 155 may include a plurality of connected data links, such as a first link between the aircraft 105 and a satellite, and a second link between the satellite and one of the ground stations 162.

Any of the one or more ground stations 162 may be connected to a system of a communications service provider that enables the aircraft 105 to transmit data to, and/or receive data from, air traffic controller 164, server system 166, and data sources 168. Data sources 168 may include, for example, internet-accessible web servers and systems that provide subscribed services, such as weather forecasts transmitted via a satellite.

Server system 166 may be part of a data center that provides services to the aircraft 105. Server system 166 may be a computer system that includes a memory storing instructions and one or more processors configured to execute the instructions to perform various computer-implemented operations described in this disclosure. In some examples, server system 166 may operate a cloud server that performs such operations. Server system 166 may be in communication with air traffic controller 164 and data sources 168 through one or more communications networks.

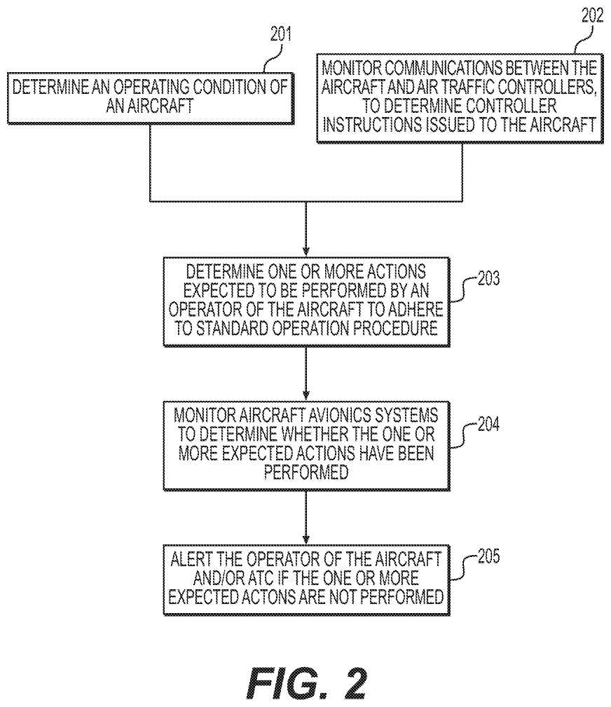

FIG. 2 illustrates a method for tracking adherence to a standard operating procedure. The method may be performed by any suitable computer system. In some examples, the computer system performing the method may be on-board computer system 110, in which case any data that is gathered or possessed by one or more of the ground systems 160 may be provided to the on-board computer system 110 through data links 155. Alternatively or additionally, the computer system performing the method may be server system 166, in which case any data that is gathered or possessed by the aircraft 105 may be provided to the sever system 166 through data links 155. Furthermore, it is also possible for various operations of the method of FIG. 2 to be divided between the on-board computer system 110 and the server system 166. Any system that includes a computer system performing the method of FIG. 2 may also be referred to as a safety management system (SMS). The aircraft referred to in various steps of FIG. 2 may be represented by aircraft 105 described above.

Step 201 may include determining an operating condition of an aircraft. Examples of operating conditions include position and movement conditions of the aircraft (e.g., position, altitude, speed, and direction of travel), characteristics of aircraft (e.g., aircraft type), characteristics of the external conditions of the aircraft, factors dependent on both the aircraft and the environment (e.g., distance from terrain), configuration settings of the aircraft, and a flight status of the aircraft (e.g., flight stage, instructions and clearances received from an air traffic controller, and the tower or air traffic controller responsible for directing the aircraft). External conditions of the aircraft may include any condition of the environment in which the aircraft is operating, such as weather conditions, nearby terrain, aerial traffic, the airspace, and characteristics of the airspace (e.g., class of airspace).

Step 202 may include monitoring communications between the aircraft and air traffic controllers to determine controller instructions issued to the aircraft. The controller instructions may be issued by any air traffic controller that is directing the aircraft. Controller instructions may include, for example, communication procedures, flight plans, flight procedures, and weather instructions. Controller instructions may also be referred to as operating instructions or operational instructions.

The computer system performing step 202 may continuously monitor radio communication (e.g., CPDLC) between the aircraft and any air traffic controller that communicates with the aircraft, and perform speech recognition on voice communication between the aircraft and any air traffic controller in order to determine the instructions. For example, the computer system performing step 202 may continuously convert the voice communication into a text transcript using a speech-to-text conversion process, and perform natural-language interpretation on the text transcript to determine the content of the instructions. The natural-language interpretation may include parsing the sentence structure of the text and determining the meaning of the text transcript. In some examples, the natural-language interpretation may be based on keyword matching or phrase matching. In some examples, the speech-to-text conversion and/or natural-language interpretation may be performed by a machine learning model (e.g., an artificial neural network) trained to interpret the voice communication and/or the text transcript.

In some situations, it may be unnecessary to perform either one or both of steps 201 and 202, if neither the operating condition nor the controller instructions are needed for step 203 described below. If steps 201 and 202 are both performed, they may be performed in any order.

Step 203 may include determining one or more actions expected to be performed by an operator of the aircraft to adhere to standard operating procedure. In this context, the standard operating procedure may be a standard operating procedure that is applicable to the current status of the aircraft. The current status of the aircraft may include the operating condition describe above, and may further include other factors, such as whether instructions have been issued to the aircraft by an air traffic controller. The one or more actions may each be actions of operating the aircraft in a certain manner that maintains adherence to the applicable standard operating procedure. The determination of step 203 may be based on any one or more relevant factors, such as the operating condition determined in step 201 and/or the controller instructions determined in step 202. It is noted that the term “adhere” is interchangeable with “comply” in the context of adhering to standard operating procedure. Additionally, an operator of an aircraft may be a pilot or any member of the aircraft's flight crew.

Step 203 may include determining an applicable standard operating procedure, and determining the one or more expected actions based on the applicable standard operating procedure.

In some examples, the applicable standard operating procedure may be selected from a set of candidate standard operating procedures. In such examples, a plurality of standard operating procedures applicable under various respective circumstances may be compiled from documents such as pilot manuals, operator manuals, checklists, workflow task lists, and sketches. Such standard operating procedures, as well as the corresponding conditions for which they are applicable, may be represented in digital format. Using a digital-format representation, an applicable standard operating procedure may be determined based on satisfaction of one or more of the conditions under which the standard operating procedures are respective applicable. For example, the operating condition determined in step 201, together with or without the controller instructions determined in step 202, may be evaluated as to whether it satisfies any of the conditions under which a stored standard operating procedure is applicable. If a condition for a standard operating procedure is satisfied, the corresponding standard operating procedure may be selected as being applicable to the aircraft.

Based on the applicable standard operating procedure, one or more actions that an operator of the aircraft should take in order to adhere to the applicable standard operating procedure may be determined. An “action” may refer to an operation performed by an operator of the aircraft. In some circumstances, an action may be particularly specified by the standard operating procedure. In other circumstances, the action may be a particular execution of a general procedure specified by the standard operating procedure. For example, tuning a radio to a frequency instructed by an air traffic controller may be regarded as a general procedure specified by a standard operating procedure, while tuning the radio to the specifically instructed frequency may be regarded as an action expected to be taken for compliance with the standard operating procedure.

Determination of the applicable standard operating procedure may be performed by an artificial intelligence (AI) model. For example, the AI model may be trained to select a standard operating procedure from the plurality of standard operating procedures, as described above, based on input data describing operating conditions, changes in operating conditions, controller instructions, and/or changes in controller instructions. The AI model may also determine the one or more expected actions based on such input data.

In some examples, the AI model may be an artificial neural network (e.g., deep neural network) or other type of machine learning model that has been trained to output the applicable standard operating condition (and/or one or more expected actions) as a function of input data describing the operating condition, controller instructions, and/or other factors relevant to determining actions that comply with standard operating procedure. The AI model may be trained using a training set comprising a plurality of data objects. Each data object may comprise a feature vector defining values for one or more input parameters, which may include any number of parameters describing operating conditions and/or controller instructions. Each data object may be given a label indicating the applicable standard operating procedure (and/or one or more expected actions) for a situation in which the conditions defined by the feature vector are present. Data objects of the training set may include feature vectors having values for any parameters used to characterize operating conditions or controller instructions. Accordingly, the AI model may be trained to determine the applicable standard operating procedure (and/or one or more expected actions) as a function of the one or more input parameters.

Step 204 may include monitoring aircraft avionics systems to determine whether the one or more expected actions determined in step 203 have been performed. To make this determination, the on-board computer system 110 may, for example, monitor the bus signal of any avionics on-board the aircraft 105 that should be operated in a certain way order to implement the one or more expected actions. The bus signal that is monitored may be determined according to the step 203. For example, the on-board computer system 110 may store a correspondence between busses and standard operating procedures, such that for a given standard operating procedure, a corresponding set of one or more relevant busses may be monitored.

Step 205 may include alerting the operator of the aircraft and/or an air traffic controller (ATC) if the one or more expected actions are not performed.

For example, if the bus signals show that the one or more expected actions determined in step 203 have not been performed, then the computer system performing step 205 may alert the crew by controlling one or more of the output devices 140 to broadcast a visual and/or aural alert to the operator of the aircraft indicating that the applicable standard operating procedure has not been complied with. The computer system may additionally present an alert to an ATC indicating that the aircraft has not complied with the applicable standard operating procedure. The alert may be presented to the ATC by transmission of a message to a computer system operated by the ATC. The ATC in step 205 may be any ATC having control over the flight. The ATC in step 205 may be different from the ATC that issued the instructions in step 202.

In some examples, the alerting in step 205 may be conditioned on satisfaction of one or more additional conditions, such as the elapse of a pre-set period of time during which the one or more expected actions have not been performed. Step 204 may be a continuous monitoring operation, and may trigger step 205 upon determining that the one or more expected actions have not been performed after elapse of the period of time.

If the ATC is alerted in step 205, the method shown in FIG. 2 may include an additional step of informing the ATC that the operator of the aircraft has properly perform the one or more expected actions.

The ATC, when alerted, may alert the operator of the aircraft as well as the surrounding aircrafts so that all the airplanes in the vicinity may take preventive action and be vigilant. Accordingly, the method of FIG. 2 may implement a safety management system that benefits many aircraft in the same region, so as to enhance the overall safety of air travel.

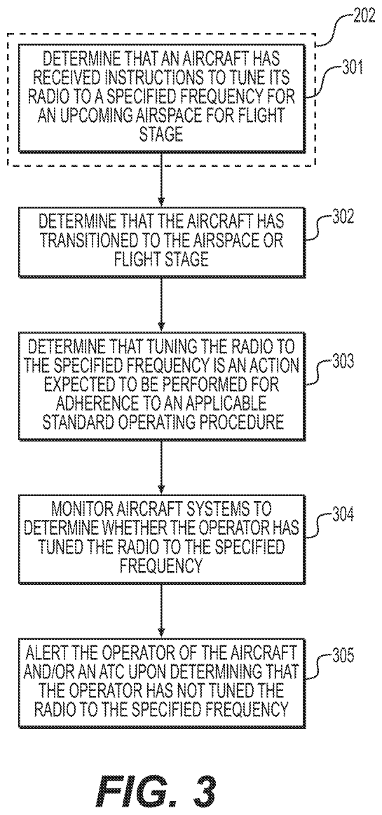

FIG. 3 illustrates an example method for tracking adherence to standard operating procedure and alerting non-adherence in the example context of radio frequencies, according to one or more embodiments of this disclosure. The method of FIG. 3 may be regarded as an example of the method of FIG. 2 described above.

In general, when an aircraft transition between various airspaces or flight stages, control of the aircraft may transition from one air traffic controller to another air traffic controller. Under standard operating procedure, the operator of the aircraft may be required to tune to different frequencies at various stages of flight, as instructed by various air traffic controllers.

Step 301 may include determining that an aircraft has received instructions to tune its radio to a specified frequency for an upcoming airspace or flight stage. The upcoming airspace or flight stage may be an airspace or flight stage different from the current airspace or flight stage. Step 301 may be performed as part of step 202 described above, and thus serves an example of a sub-step of step 202. In step 301, the instructions may be received from an air traffic controller over voice communication, and the voice communication may be analyzed as described above in relation to step 202, such that the instructions to tune the aircraft's radio is determined from the voice communication.

Examples of flight stages include preflight stages (e.g., clearance delivery), departure, en route or cruise, descent, approach, and landing. However, in general, a flight stage may be any portion of the flight associated with certain flight procedures.

Step 302, which is an example of step 201 of FIG. 1, may include determining that the aircraft has transitioned to the airspace or flight stage determined in step 301. This determination may be based on factors such as the position, altitude, and/or pitch of the aircraft. A determination that the aircraft has transitioned to a certain airspace or flight stage may be performed by determining that the aircraft is currently in that airspace or flight stage.

The determination of whether a position of the aircraft is within a certain airspace may utilize airspace data describing airspace characteristics of the country or region in which the aircraft is flying. Such airspace data may define boundaries of various airspaces in the country or region in which the aircraft is traveling. In some examples, the computer system performing step 302 may query a database, such as a database storing the airspace data described above, that allows airspace to be determined based on position. The database used for airspace determination may be locally stored on the computer system performing step 301. Additionally or alternatively, the database may be stored in a remote data source (e.g., one of the data sources 168) accessible through a network such as the Internet. In such examples, the mode of access to the Internet to acquire the airspace data may vary depending on where the computer system performing step 301 is located. If the computer system is on-board computer system 110, then the connection to the Internet may be, for example, through SATCOM implemented by communications systems 150.

The determination of whether a position of the aircraft is within a certain flight stage may be based on factors such as a planned route, and the position and altitude of the aircraft. The flight plan may be stored in the on-board computer system 110, and the computer system performing the determination may, for example, compare the current position of the aircraft with positions on the planned route.

Step 303 may include determining that tuning the radio to the specified frequency is an action expected to be performed for adherence to the applicable standard operating procedure. Step 304 may include monitoring aircraft systems to determine whether the operator has tuned the radio to the specified frequency. This step may include monitoring a bus line of the radio to read its frequency setting. Step 305 may include alerting the operator of the aircraft and/or an ATC upon determining that the operator has not tuned the radio to the specified frequency. Steps 303, 304, and 305 are examples of steps 203, 204, and 205, and may be performed using any of the methodologies described for 203, 204, and 205.

For example, during the clearance delivery stage, an operator of an aircraft may receive, from an air traffic controller, a communication providing instrument flight rules (IFR) clearance. The communication may be a voice communication, and may indicate various clearance elements such as a clearance limit, a route of flight, an altitude of climb, a frequency to which the operator of the aircraft should tune, and a transponder code. Accordingly, in the context of clearance delivery, step 301 may include determining the clearance limit, route of flight, altitude, frequency, and transponder code instructed by the air traffic controller.

The communication may include instructions in a format used in aviation communications. For example, the communication may include a verbal statement such as “[Call sign and flight number], cleared to [destination] via radar vectors to [position] then as filed. Fly runway heading. Climb and maintain seven thousand feet; expect one five thousand fifteen minutes after departure. Departure on 123.4, squawk 0356.” Here, the placeholder “call sign and flight number” may refer to the call sign and flight number of the aircraft (e.g., “United seven-six” for United Airlines flight 76), and the placeholder “destination” may be a destination airport, and the position may be, for example, a fix. Step 301, as applied to the context of clearance delivery, may include converting the verbal statement into text, and interpreting the text to determine the clearance limit, route of flight, altitude, frequency, and/or transponder code. In this context of clearance delivery, an AI model as described above may be trained to recognize the clearance elements. Such training may be facilitate by commonly occurring keywords (e.g., “cleared to”) and sentence structures used in aviation communication.

In the context of clearance delivery, the upcoming flight stage for purposes of step 302 may be any stage of the flight plan following the departure stage, and the expected action for purpose of step 303 may be tuning the radio to 123.4. The tuning of the radio is an example of an expected action for compliance with a standard operating procedure. The expected action, for purposes of step 203, may also be any action to comply with one of the clearance elements, including the direction of flight at a certain point after takeoff, the altitude of climb, and the transponder code. In the case of the altitude, step 201 may involve determining whether the altitude of the aircraft is improper at a certain stage of the flight after takeoff.

As another example, after the aircraft has left ground, it may be receive instructions from departure control to be sequenced out of the airport's airspace. The departure control may instruct the aircraft to reach a certain cruising altitude. Compliance with the instructed cruising altitude, at a certain point after takeoff, may be an expected action for adherence to standard operating procedures.

As another example, once the aircraft is free of departure's airspace, the departure control may clear the aircraft to contact a central controller, such as any one of the Air Route Traffic Control Centers (ARTCC) in the United States. For example, if the aircraft is to travel through an airspace controlled by the Oakland Air Route Traffic Control Center, the departure control may send a communication to the aircraft specify a frequency for the Oakland center control (e.g., “contact Oakland Center on 128.9.”). Later during the flight, if the aircraft is to transition to an airspace controlled by the Seattle Air Route Traffic Control Center, the Oakland center control may send a communication to the aircraft specifying a frequency for the Seattle center control (e.g., contact Seattle Center on 128.7”).

In the above examples, step 301 may include determining the frequency specified by the respective controller (e.g., the departure control or the Oakland center control) and the airspace for which the frequency applies (e.g., the Oakland center airspace or the Seattle Center airspace), step 302 may include determining that the position of the aircraft is within the airspace for which the frequency applies, step 303 may include determining that the operator of the aircraft should tune the radio to the specified frequency (e.g., 128.9 or 128.7), and step 304 may include monitoring the radio to determine whether the frequency has been applied.

As the aircraft nears its destination, it will be handed off to approach control. For example, if the aircraft is to land in Portland, the Seattle Center may communicate a frequency for the approach control for Portland. Approach control may later specify a certain frequency for the tower that provides clearance for landing. The method of FIG. 2 may be applied to these situations, in a manner analogous to the situations described above.

Accordingly, the method of FIG. 2 may be implemented to track the change of flight phases or airspace that require a radio frequency change, and may alert the operator of the aircraft if the expected radio frequency change is not performed.

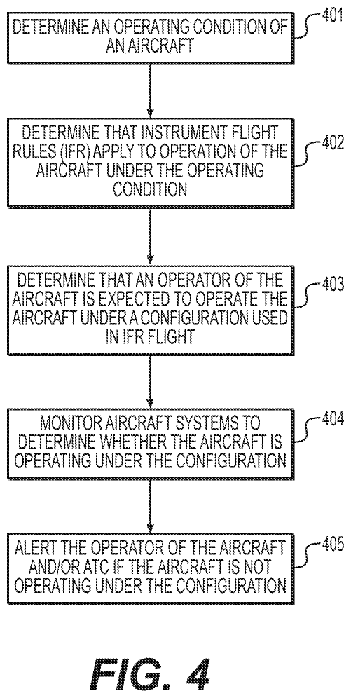

FIG. 4 illustrates an example method for tracking adherence to standard operating procedure and alerting non-adherence in the example context of proper configurations for instrument flight rules (IFR) flight, according to one or more embodiments of this disclosure. The method of FIG. 4 may be regarded as an example implementation of the method of FIG. 2 described above.

Step 401 may include determining an operating condition of an aircraft. Step 402 may include determining that instrument flight rules (IFR) apply to operation of the aircraft to the operating condition. Step 403 may include determining that an operator of the aircraft is expected to operate the aircraft under a configuration used in IFR flight. Step 404 may include monitoring aircraft systems to determine whether the aircraft is operating with the configuration. Step 405 may include alerting the operator of the aircraft and/or an air traffic controller (ATC) if the aircraft is not operating under the configuration. Steps 401, 404 and 405 are examples of steps 201, 204, and 205. Steps 402 and 403 are example sub-steps of step 203. It is noted that step 202 of FIG. 2 is not necessary for the method of FIG. 4.

For example, referring again to FIG. 1, the warning systems 140 may include a TAWS or ACAS warning system configured to issue a safety alert upon detection of a condition hazardous to safety based on readings from any one or more of the sensor systems 130 (e.g., aircraft position, speed, direction, and/or altitude) and/or other available information, such as a terrain database stored on the on-board computer system 110 or information provided by ground-based systems 160. The safety alert may aural and/or visual and may be presented to the operator of the aircraft through output devices 122. The medium and/or content of the safety alert may depend on the particular circumstances triggering the alert.

Such a warning system (e.g., TAWS or ACAS) may have a functionality of allowing the operator of the aircraft to set one or more alerts given by the warning system to an inhibited state. In some examples, such functionality may be implemented by a switch that may be switched on and off to respectively engage (activate) and disengage (deactivate) the inhibition of the alert. However, if the aircraft is operating under conditions requiring instrument flight rules, the applicable standard operating procedure may specify that the inhibition of the safety alert should be deactivated.

For example, step 401 may include determining a position (including altitude), and an external weather condition of the aircraft at the position, and may further include determining that the position of the aircraft indicates that the aircraft is within a certain airspace or type (e.g., class) of airspace. The position and altitude may be determined based on the position sensors 134, and the external weather conditions may be determined based on radar 132 (e.g., a weather radar) and/or data from a data source 168, which in this context may be a satellite weather service or a ground-based data center, for example.

In the above example, step 402 may include determining that IFR applies to operation of the aircraft under the operating condition by determining that the weather conditions determined in step 401 do not satisfy the visual meteorological conditions (VMC) minima applicable to the aircraft's position. The VMC minima may be determined based on the type of airspace and altitude band in which the position of the aircraft is located.

In the above example, step 403 may include determining that the aircraft is expected to operate under the configuration in which the inhibition of safety alert of the warning system should be deactivated, in order for the aircraft to adhere to standard operating procedure. Step 404 may include monitoring a bus of the warning system to determine whether the inhibition of the safety alert is deactivated. If the inhibition is not deactivated, then the operator and an ATC may be alerted in step 405.

Accordingly, systems and methods according to this disclosure may realize the benefit of tracking of the crew actions that should be performed for any change in aircraft operating conditions and alerting the aircraft crew and/or ATC if the aircraft is not adhering to procedures that needs to be executed for the operating conditions. Therefore, computer systems used in aircraft avionics and flight safety management may be improved by implementation of the methodologies described in this disclosure.

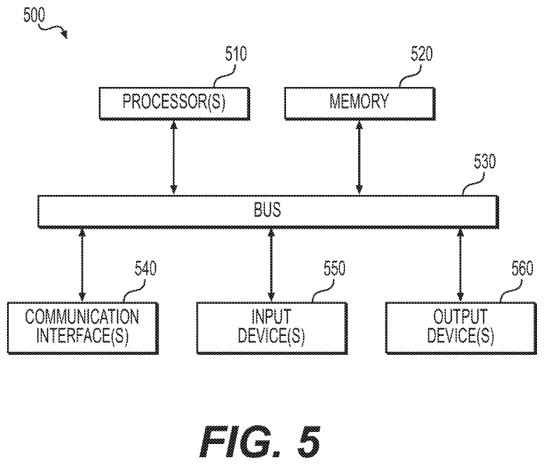

FIG. 5 illustrates an example of a computing device 500 of a computer system that may execute techniques presented herein. The computing device 500 may include processor(s) 510 (e.g., CPU, GPU, or other such processing unit(s)), a memory 520, and communication interface(s) 540 (e.g., a network interface) to communicate with other devices. Memory 520 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 520. The computing device 500 may, in some embodiments, further include input device(s) 550 (e.g., a keyboard, mouse, or touchscreen) and output device(s) 560 (e.g., a display, printer). The aforementioned elements of the computing device 500 may be connected to one another through a bus 530, which represents one or more busses. In some embodiments, the processor(s) 510 of the computing device 500 include both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

1. A computer-implemented method for alerting non-compliance with aviation standard operating procedures, the method comprising:
determining an operating condition of an aircraft, based at least in part on a determination that instrument flight rules apply due to assessed visual meteorological conditions;
based on the determined operating condition, determining one or more actions expected to be performed by an operator of the aircraft to operate the aircraft according to the instrument flight rules and adhering to a standard operating procedure applicable to the operating condition;
determining whether the one or more actions have been performed; and
upon determining that the one or more expected actions have not been performed, alerting the operator or an air traffic controller to indicate that the aircraft is not adhering to the applicable standard operating procedure.

2. The method of claim 1, further comprising:
determining controller instructions issued to the aircraft by an air traffic controller,
wherein in the determining the one or more actions, the one or more actions is determined based further on the determined controller instructions.

3. The method of claim 2, wherein
the instructions specify that aircraft is to tune a radio of the aircraft to a specified frequency for an upcoming airspace or flight stage,
the determining the operating condition includes determining that the aircraft has transitioned to the upcoming airspace or flight stage, and
the one or more actions includes tuning the radio of the aircraft to the specified frequency.

4. The method of claim 2, wherein the determining the controller instructions includes:
monitoring radio communication between the aircraft and the air traffic controller directing the aircraft; and
performing speech recognition on the radio communication to determine the instructions.

5. The method of claim 1, wherein the determining the one or more actions includes:
using a trained machine learning model to process input data comprising the operating conditions, to thereby obtain the one or more actions.

6. (canceled)

7. The method of claim 1, wherein
the one or more actions include operating an avionics system of the aircraft in a manner adhering to the applicable standard operating procedure, and
the determining whether the one or more actions have been performed includes determining a bus line of the avionics system and monitoring the bus line.

8. A computer system for alerting non-compliance with aviation standard operating procedures, the computer system comprising:
a memory storing instructions; and
one or more processors configured to execute the instructions to perform operations including:
determining an operating condition of an aircraft, based at least in part on a determination that instrument flight rules apply due to assessed visual meteorological conditions;
based on the determined operating condition, determining one or more actions expected to be performed by an operator of the aircraft to operate the aircraft according to the instrument flight rules and adhering to a standard operating procedure applicable to the operating condition;
determining whether the one or more actions have been performed; and
upon determining that the one or more expected actions have not been performed, alerting the operator or an air traffic controller to indicate that the aircraft is not adhering to the applicable standard operating procedure.

9. The computer system of claim 8, wherein
the operations further include determining controller instructions issued to the aircraft by an air traffic controller, and
in the determining the one or more actions, the one or more actions is determined based further on the determined controller instructions.

10. The computer system of claim 9, wherein
the instructions specify that aircraft is to tune a radio of the aircraft to a specified frequency for an upcoming airspace or flight stage,
the determining the operating condition includes determining that the aircraft has transitioned to the upcoming airspace or flight stage, and
the one or more actions includes tuning the radio of the aircraft to the specified frequency.

11. The computer system of claim 9, wherein the determining the controller instructions includes:
monitoring radio communication between the aircraft and the air traffic controller directing the aircraft; and
performing speech recognition on the radio communication to determine the instructions.

12. The computer system of claim 8, wherein the determining the one or more actions includes:
using a trained machine learning model to process input data comprising the operating conditions, to thereby obtain the one or more actions.

13. (canceled)

14. The computer system of claim 8, wherein
the one or more actions include operating an avionics system of the aircraft in a manner adhering to the standard operating procedure, and
the determining whether the one or more actions have been performed includes determining a bus line of the avionics system and monitoring the bus line.

15. A non-transitory computer-readable medium storing instructions that, when executed by one or more processors of a computer system, cause the one or more processors to perform a method for alerting non-compliance with aviation standard operating procedures, the method comprising:
determining an operating condition of an aircraft, based at least in part on a determination that instrument flight rules apply due to assessed visual meteorological conditions;
based on the determined operating condition, determining one or more actions expected to be performed by an operator of the aircraft to operate the aircraft according to the instrument flight rules and adhering to a standard operating procedure applicable to the operating condition;
determining whether the one or more actions have been performed; and
upon determining that the one or more expected actions have not been performed, alerting the operator or an air traffic controller to indicate that the aircraft is not adhering to the applicable standard operating procedure.

16. The non-transitory computer-readable medium of claim 15, wherein the method further comprises:
determining controller instructions issued to the aircraft by an air traffic controller,
wherein in the determining the one or more actions, the one or more actions is determined based further on the determined controller instructions.

17. The non-transitory computer-readable medium of claim 16, wherein
the instructions specify that aircraft is to tune a radio of the aircraft to a specified frequency for an upcoming airspace or flight stage,
the determining the operating condition includes determining that the aircraft has transitioned to the upcoming airspace or flight stage, and
the one or more actions includes tuning the radio of the aircraft to the specified frequency.

18. The non-transitory computer-readable medium of claim 16, wherein the determining the controller instructions includes:
monitoring radio communication between the aircraft and the air traffic controller directing the aircraft; and
performing speech recognition on the radio communication to determine the instructions.

19. The non-transitory computer-readable medium of claim 15, wherein the determining the one or more actions includes:
using a trained machine learning model to process input data comprising the operating conditions, to thereby obtain the one or more actions.

20. (canceled)

21. The method of claim 1, further comprising deactivating an inhibition of a safety alert, based at least in part on the determination that instrument flight rules apply.

22. The computer system of claim 8, wherein the operations further include deactivating an inhibition of a safety alert, based at least in part on the determination that instrument flight rules apply.

23. The non-transitory computer-readable medium of claim 15, wherein the method further comprises deactivating an inhibition of a safety alert, based at least in part on the determination that instrument flight rules apply.
